(19) United States
(12) Patent Application Publication
(10) Pub. No.: US 2005/0040040 A1
(43) Pub. Date: Feb. 24, 2005

(54) Gas sensor

(76) Inventors: Thomas Wahl, Pforzheim (DE); Torsten Handler, Stuttgart (DE)

Correspondence Address: KENYON & KENYON, ONE BROADWAY, NEW YORK, NY, 10004, US

(21) Appl. No.: 10/496,719

(22) PCT Filed: Oct. 2, 2002
(86) PCT No.: PCT/DE02/03716

(30) Foreign Application Priority Data
Nov. 24, 2001 (DE) 101 57 734.6

(51) Int. Cl. G01N 27/26

(52) U.S. Cl. 204/427; 204/426

(57) ABSTRACT

A gas-measuring sensor, preferably for verifying at least one physical variable of a gas, in particular for verifying the oxygen concentration in an exhaust gas of an internal combustion engine, the sensor including a sensor element, which has an electrochemical cell having a first electrode and a second electrode and at least one solid electrolyte electrically connecting the first and the second electrode. The second electrode is provided in a reference-gas region containing a reference gas. The reference-gas region is arranged between the first and the second electrode.

### BACKGROUND INFORMATION

A gas-measuring sensor is described in German Patent No. 100 58 643, for instance. The gas-measuring sensor has a sensor element including a first, a second and a third solid electrolyte member arranged in the form of layers. Applied on the first solid electrolyte member, on an outer surface of the sensor element, is a first electrode. A second electrode is provided on the side of the first solid electrolyte member lying across from the first electrode. The second electrode is arranged in a reference-gas region between the first and the second solid electrolyte member. The first and the second electrode as well as the solid state electrolyte arranged between the electrodes form an electrochemical cell, such as a Nernst cell. The reference-gas region, which may be filled with a porous material, contains a reference gas, such as air. A heater for heating the sensor element is provided between the second and the third solid electrolyte member, the heater being separated from the surrounding solid electrolyte members by heater insulation.

Furthermore, it is known to select the dimensions of the solid electrolyte members such that the heater is centrally positioned inside the sensor element. To this end, the first and the second solid electrolyte members, for instance, are only half as thick as the third solid electrolyte member.

In order to ensure a reliable functioning of the sensor element, the heater maintains a constant temperature of the sensor element, regardless of external influences, such as the temperature of the exhaust gas. For this the heater is controlled by evaluation electronics arranged outside of the sensor element. To control the heater, the temperature of the sensor element is determined. It is known to use the temperature-dependent internal resistance of an electrochemical cell for this purpose. Consequently, the internal resistance of the electrochemical cell, made up of the first and the second electrode as well as the solid electrolyte member arranged between the first and second electrode, is entered into the input variable for the control of the heater. To determine the internal resistance, the evaluation electronics applies a voltage, such as an a.c. voltage or voltage pulses, between first and second electrodes, the resulting current being measured.

Disadvantageous in the sensor element according to the present invention is that the internal resistance between the first and second electrode is so low that the temperature-related changes in the internal resistance are not large enough for resolving them with sufficient accuracy, for instance with the aid of the electronic circuits commonly used in motor vehicles. Furthermore, the temperature dependency of the internal resistance is low compared to the production-related fluctuations. Therefore, the control of the heater entails a major error.

### SUMMARY OF THE INVENTION

The gas sensor according to the present invention has the advantage that it increases the internal resistance by the arrangement of the reference-gas region inside the electrochemical cell, that is to say, between the first and second electrode. Furthermore, the characteristic curve of the internal resistance as a function of the temperature is improved, thereby allowing a precise regulation of the heater. Due to a steeper gradient the characteristic line has better resolution capacity. Thus, the use of less complicated circuits and of cost-effective analog-digital converters is possible.

If the heater is not regulated via the internal resistance, but on the basis of other characteristic quantities, the temperature of the sensor element may be monitored more closely due to the improved resolution. The higher internal resistance may also be desirable for other reasons related to circuit-technology.

A precise regulation of the heater may be obtained if, given a temperature of the sensor element of 600 degrees Celsius, the internal resistance between the first and the second electrode lies within the range of 400 to 1200 Ohm, preferably 800 Ohm and, given a temperature of the sensor element of 700 degrees Celsius, within the range of 100 to 300 Ohm, preferably 150 to 200 Ohm.

In a preferred exemplary embodiment of the present invention, the width of the second electrode, i.e., the extension of the second electrode in its plane of stratification perpendicular to the longitudinal axis of the sensor element is less than the width of the reference-gas region. The reference-gas region is arranged between a first and a second solid electrolyte member and surrounded by a solid electrolyte layer along the sides. The first electrode is applied on an outer surface of the first solid electrolyte member and the second electrode is applied inside the reference-gas region, on the second solid electrolyte member. Thus, the second electrode is in direct contact only with the second solid electrolyte member, but not with the solid electrolyte layer or with the first solid electrolyte member. Consequently, the second electrode is likewise electrically connected only to the solid electrolyte layer, the first solid electrolyte member and, finally, the first electrode, via the second solid electrolyte member.

If a supply lead to the second electrode, by which the second electrode is electrically connected to a contact surface that is situated at the end of the sensor element facing away from the second electrode, is arranged adjacent to the reference-gas region, the supply lead to the second electrode is electrically shielded by the reference-gas region, thereby reducing in-couplings into the supply lead to the second electrode.

The internal resistance between the first and the second electrode is advantageously increased further by a reduction in the area of the first electrode relative to the area of the second electrode.

### BRIEF DESCRIPTION OF THE DRAWINGS

FIG. 1 shows a cross-section of a sensor element of a gas-measuring sensor according to the present invention.

FIG. 2 shows the dependency of the internal resistance on the temperature for a sensor element according to the present invention and for a sensor element according to the related art.

### DETAILED DESCRIPTION

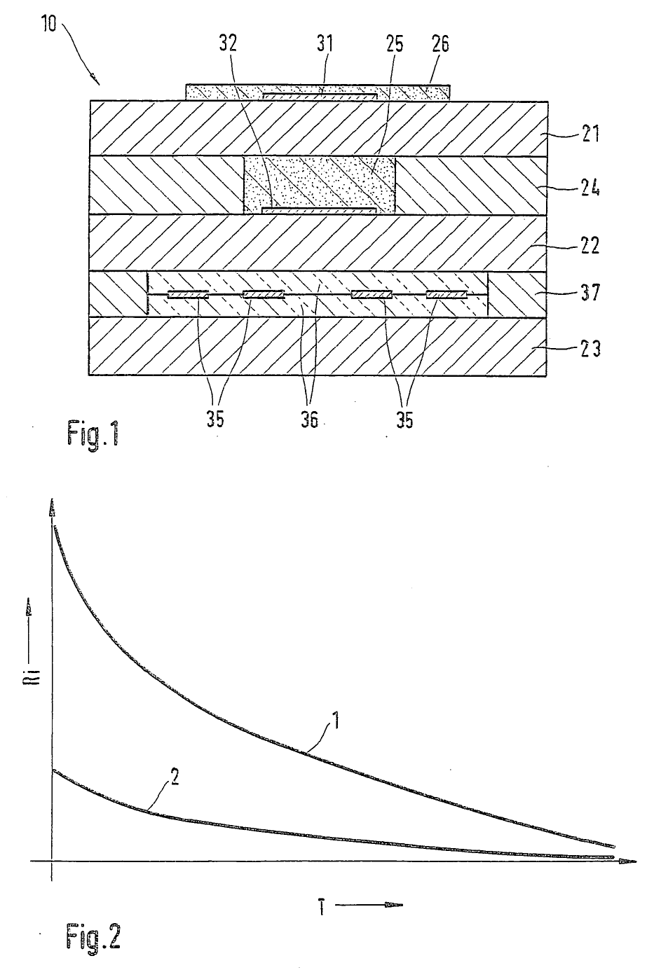

FIG. 1 schematically shows as an exemplary embodiment of the present invention a planar sensor element 10 having a layer-type structure and a first, a second and a third solid electrolyte member 21, 22, 23 made of an ion-conducting material. A first electrode 31, which is exposed to a measuring gas, is arranged on first solid electrolyte member 21, on the outer surface of sensor element 10. First electrode 31 is covered by a porous protective layer 26. Arranged on the side of first solid electrolyte member 21 lying across from first electrode 31, between first and second solid electrolyte member 21, 22, is a reference-gas region 25, which is filled with an electrically insulating, porous material, such as porous aluminum oxide. Reference-gas region 25 contains a reference gas, such as atmospheric air, extends along the longitudinal axis of sensor element 10 and is in contact with the atmospheric air by the end of sensor element 10 (not shown) that is exposed to the atmospheric air. Reference-gas region 25 is surrounded on its sides by a solid electrolyte layer 24.

A second electrode 32 is provided on second solid electrolyte member 22 in reference-gas region 25. In this way second electrode 32 is situated on the side of reference-gas region 25 facing second solid electrolyte member 22. First electrode 31 and second electrode 32 are electrically connected by first and second solid electrolyte members 21, 22 as well as by solid electrolyte layer 24 and are operated as electrochemical cell (Nernst cell) by an external circuit element. The width of second electrode 32, that is, the horizontal extension of second electrode 32 in the sectional plane shown in FIG. 1, perpendicular to the longitudinal axis of sensor element 10, is less than the width of reference-gas region 25. As a result, second electrode 32 is situated in reference-gas region 25 in such a way that the second electrode has no direct contact to solid electrolyte layer 24 and thus is also not directly connected electrically to solid electrolyte layer 24, but only via second solid electrolyte member 22.

Provided between second solid electrolyte member 22 and third solid electrolyte member 23 is a heater 35, which is electrically insulated from surrounding solid electrolyte members 22, 23 by a heater insulation 36. Heater 35 is laterally surrounded by a sealing frame 37. The thickness of third solid electrolyte member 23 is approximately twice as great as the respective thicknesses of first and second solid electrolyte members 21, 22. Thus, heater 35 is centrally positioned in sensor element 10 (shown not true to scale in FIG. 1).

Reference-gas region 25 and solid electrolyte layer 24 as well as electrodes 31, 32, and heater 35 having heater insulation 36 and sealing frame 37 are produced by printing corresponding functional layers onto so-called initial blanks (solid electrolyte members prior to sintering), using screen printing. The printed initial blanks are laminated together and sintered.

In additional specific embodiments of the present invention (not shown), reference-gas region 25 may also be embodied as cavity or be only partially filled with a porous material.

In FIG. 2, the dependency of the internal resistance (Ri) on the temperature of the sensor element (T) is illustrated. The curve denoted by 1 represents the profile of the internal resistance of the exemplary embodiment of the present invention shown in FIG. 1. The curve denoted by 2 corresponds to the profile of the internal resistance for the sensor element described in connection with the related art, in which the first and the second electrode are arranged on opposite sides, directly on the first solid electrolyte member, that is to say, in which the second electrode is provided on the side of the reference-gas region that faces the first solid electrolyte member. It can be seen clearly that the internal resistance of a sensor element according to the exemplary embodiment of the present invention (FIG. 1) is considerably higher and also has a greater negative slope than a sensor element according to the related art, so that a more precise assignment of the internal resistance to the temperature is possible. In the present exemplary embodiment, the internal resistance between first and second electrode (31, 32) amounts to 700 ohm at a temperature of 600 degrees Celsius of sensor element 10. When the temperature of sensor element 10 amounts to 700 degrees Celsius, the internal resistance is 175 ohm.

The present invention is not restricted to the described exemplary embodiment. For example, it may also be transferred to a sensor element in which the electrochemical cell is operated as a pump cell. It is likewise conceivable that the sensor element has a plurality of electrochemical cells of which one or several, in particular one electrochemical cell(s), whose internal resistance is/are utilized for measuring or regulating the temperature, or which is/are operated as Nernst cell, has the features of the present invention.

1-9. (Cancelled)

10. A gas-measuring sensor comprising a sensor element having an electrochemical cell including:
a first electrode;
a second electrode;
at least one solid electrolyte electrically connecting the first and second electrodes; and
a reference-gas region containing a reference gas, the second electrode being situated in the reference-gas region, the reference-gas region being situated between the first and second electrodes.

11. The gas-measuring sensor according to claim 10, wherein the sensor is for verifying at least one physical variable of a gas.

12. The gas-measuring sensor according to claim 11, wherein the sensor is for verifying an oxygen concentration in an exhaust gas of an internal combustion engine.

13. The gas-measuring sensor according to claim 10, wherein, with a temperature of the sensor element of 600 degrees Celsius, an internal resistance between the first and second electrodes is within a range of 400 to 1200 ohm, and, with a temperature of the sensor element of 700 degrees Celsius, the internal resistance is within range of 100 to 300 ohm.

14. The gas-measuring sensor according to claim 13, wherein, with a temperature of the sensor element of 600 degrees Celsius, the internal resistance is between 750 and 850 ohm, and, with a temperature of 700 degrees Celsius, the internal resistance is between 150 and 200 ohm.

15. The gas-measuring sensor according to claim 10, further comprising a heater, and wherein the at least one solid electrolyte includes first, second and third solid electrolyte members, the first solid electrolyte member being situated between the first electrode and the reference-gas region, the second solid electrolyte member being situated between (a) one of the reference-gas region and the second electrode and (b) the heater, and the third solid electrolyte member being situated on a side of the heater facing away from the first and second solid electrolyte members.

16. The gas-measuring sensor according to claim 10, further comprising a porous, electrically insulating material situated in the reference-gas region.

17. The gas-measuring sensor according to claim 16, wherein the insulating material includes porous aluminum oxide.

18. The gas-measuring sensor according to claim 10, further comprising a heater and a device for regulating the heater, an internal resistance between the first and second electrodes being entered into an input variable for regulating the heater.

19. The gas-measuring sensor according to claim 15, wherein the heater, which is electrically insulated from the surrounding solid electrolyte members by a heater insulation, is centrally situated in the sensor element.

20. The gas-measuring sensor according to claim 10, wherein a width of the second electrode is less than a width of the reference-gas region.

21. The gas-measuring sensor according to claim 10, wherein a supply lead to the second electrode, via which the second electrode is electrically connected to a contact surface situated on a side of the sensor element facing away from the second electrode, adjoins the reference-gas region situated along a longitudinal axis of the sensor element.

22. The gas-measuring sensor according to claim 10, wherein a perpendicular projection of the first electrode onto a plane of stratification of the second electrode lies at least regionally on the second electrode.
